(19) United States
(12) Patent Application Publication
(10) Pub. No.: US 2006/0155705 A1
(43) Pub. Date: Jul. 13, 2006

(54) Managing hierarchical authority to access files in a shared database

(76) Inventors: Robert J. Kamper, Round Rock, TX (US); Kulvir Singh Bhogal, Fort Worth, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/032,184

(22) Filed: Jan. 10, 2005

(51) Int. Cl. G06F 17/30

(52) U.S. Cl. 707/8

(57) ABSTRACT

A method, system, and program product that enable dynamic scheduling/arranging of access by multiple users to a single electronic file. A network-database access management utility (NAMU) is provided, which manages/schedules network-level access to the electronic file. NAMU includes an access-request queue that schedules/arranges the user identifier (IDs) for each of multiple users that have requested access to the file while the file was checked out to a previous user. When the first user completes his access to the file and closes the file, an alert is generated for the next user in queue. This alert informs the next user that the first user has closed the file and that he/she may now access the electronic file.

### BACKGROUND OF THE INVENTION

1. Technical Field

The present invention relates generally to shared databases and specifically to user access to electronic files in a shared database. Still more specifically, the present invention relates to managing access by multiple users to electronic files in a shared database.

2. Description of the Related Art

In a computer network environment, a single electronic file may be accessed/utilized by multiple users using one or more client systems. The electronic file may be stored on a network database or other storage device that is accessible to the client systems via network connections.

While multiple users may access a single file, conventional systems allow for only a one-at-a-time access to the master/parent copy of the file. For example, in a document processing context with a networked document, both a first user of a first client system and a second user of a second client system may wish to access the networked file. Assuming the first user requests access to the document before the second user, the first user is provided the parent copy of the document and may edit the parent copy.

Once the document (file) is provided to the first user, the network system (i.e., server and associated management software) locks the file so that other users will not be able to make changes/edits to the file. The file remains locked to other users until the first user relinquishes access to the file. Thus, if the second user attempts to open the document while it is still checked out to the first user, the network system manager displays some sort of warning or information dialog alerting the second user that the file is locked for editing by another user.

Frequently, the second user is provided with an option of opening another (child) copy of the document, which may only be edited as such and has to be saved as a different document with a different file name. Assuming the second user wishes to edit the parent file, the second user must initiate attempts to access and edit the file at a later time when the file is no longer locked due to the first user's access.

Notably, in this conventional method of enabling only sequential access to a parent copy of a file, if the first user does not close the file after the first user has completed editing the file, other users wishing to edit the file may be locked out for an indefinite period of time. Also, since the other users are not aware of when the first user completes his/her access of the file, these other users are forced to continually try to access the file at some later time. This may ultimately result in a third user gaining access to the file before the second user, who was first to request access while the file was opened by the first user. These problems may become more visible with collaborative and group work that utilizes file databases when more than one person wants to edit a file at the same time.

The present invention thus recognizes that it would be advantageous to be able to schedule user access to a shared/networked file so that a next scheduled user is able to edit the file as soon as the prior user has finished editing and has closed the file. This and other benefits are provided by the invention described herein.

### SUMMARY OF THE INVENTION

Disclosed is a method, system and program product that enables dynamic scheduling/arranging of access by multiple users to a single electronic file. A network-database access management utility (NAMU) is provided, which manages/schedules network-level access to the electronic file. NAMU includes an access-request queue that schedules/arranges the user identifier (IDs) for each of multiple users that have requested access to the file while the file was checked out to a previous user.

When the previous user completes his access to the file by closing the file or giving up editing rights to the parent copy of the file, an alert is generated for the next user in queue. This alert informs the next user that the first user has released the parent file and that the next user may now access the parent file. In another embodiment, the queued users may select an option to automatically open the file for editing on his/her computer when the previous user releases the parent file. In this automated implementation, the file-processing application of the next user is triggered to automatically open on the next user's client system with the parent file opened within the application GUI and displayed to the next user. One extension of this embodiment provides a blinking GUI object to alert the next user when the file has been opened on his client system.

In one implementation, the invention provides a hierarchy within the queue. In a related implementation, during file creation, a user may specify the team members who will be accessing the file. The user may also associate priorities for each of the team members (users). This may be automatically generated using a default hierarchy specified by the database owner or using a project/department directory listing. This enables a project manager to be able to jump ahead of a user with lesser authority in a database-specific or file-specific hierarchy for that queue. In one implementation, a set of restricted times are defined during which only certain, pre-specified users may edit the file. For example, only users with management IDs may access a file within the 24 hours preceding a meeting or the due date for the file.

In another embodiment, the time in queue is limited and/or a time-out mechanism is provided to prevent false “in-use” conditions (i.e., a file appears to be in use by user who has forgotten to release the file). When a user does not respond to a message from the network/application administration to continue editing a file (by indicating that the file is still being edited by the user), then the user's access is timed out. The user may respond by selecting a “still in use” option or releasing the file. According to one embodiment, with the later option, the user may release the parent copy of the file but retain a child copy for non-editing purposes. When the user is timed-out, a message of the time-out is sent to the user, and the user is moved to end of queue. Contemporaneously, the next user in queue is sent a message that he/she may access the file.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of a network with a network database accessible by various client systems according to one embodiment of the invention;

FIG. 2 is block diagram representation of a data processing system within which the features of the invention may advantageously be implemented;

FIG. 3 is a block diagram representation of a network-database access management utility (NAMU) utilized to arrange user's access requests within a queue according to one implementation of the present invention;

FIG. 4 is a flow chart depicting a response to a request for access to a parent file by a second user while a previous user has the file open; and

FIG. 5 is a flow diagram illustrating the access time-out process during access to a file by multiple users in accordance with one embodiment of the invention.

### DETAILED DESCRIPTION OF AN ILLUSTRATIVE EMBODIMENT

The present invention provides a method and apparatus for “camping on” to a database record or electronic file locked by a current user so that the next user is automatically alerted when the parent file becomes unlocked/closed by the current (i.e., previous) user. The invention enables dynamic scheduling/arranging of access to a single electronic file by multiple users. Network-database access management utility (NAMU) is provided, which manages/schedules network-level access to the electronic file. NAMU includes an access-request queue that schedules/arranges the user identifier (IDs) for each of multiple users that have requested access to the file while the file was checked out to a previous user.

As utilized herein, the file (or electronic file or document) is the parent/master copy of the file that maintains the attributes of the file, such as filename, etc., when saved. The parent copy is the copy that is stored at the database with the given filename and is the copy that is being accessed for editing. One or more child copies, which do not have the attributes of the parent copy (specifically the filename) may be provided to users who do not have current access to the parent copy. The invention primarily focuses on the managing/arranging of access to a parent copy, irrespective of accesses to child copies of the file. The invention finds great applicability with word processing documents, but is capable of being implemented across any type of application file that may be created and updated by user-application, stored at a database, and opened by different users using different client systems.

When the previous user completes his access to the file by closing the file or giving up editing rights to the parent copy of the file, an alert is generated for the next user in queue. This alert informs the next user that the first user has released the parent file and that the next user may now access the parent file. In another embodiment, the queued users may select an option to automatically open the file for editing on his/her computer when the previous user releases the parent file. In this automated implementation, the file-processing application of the next user is triggered to automatically open on the next user's client system with the parent file opened within the application GUI and displayed to the next user. One extension of this embodiment provides a blinking GUI object to alert the next user when the file has been opened on his client system.

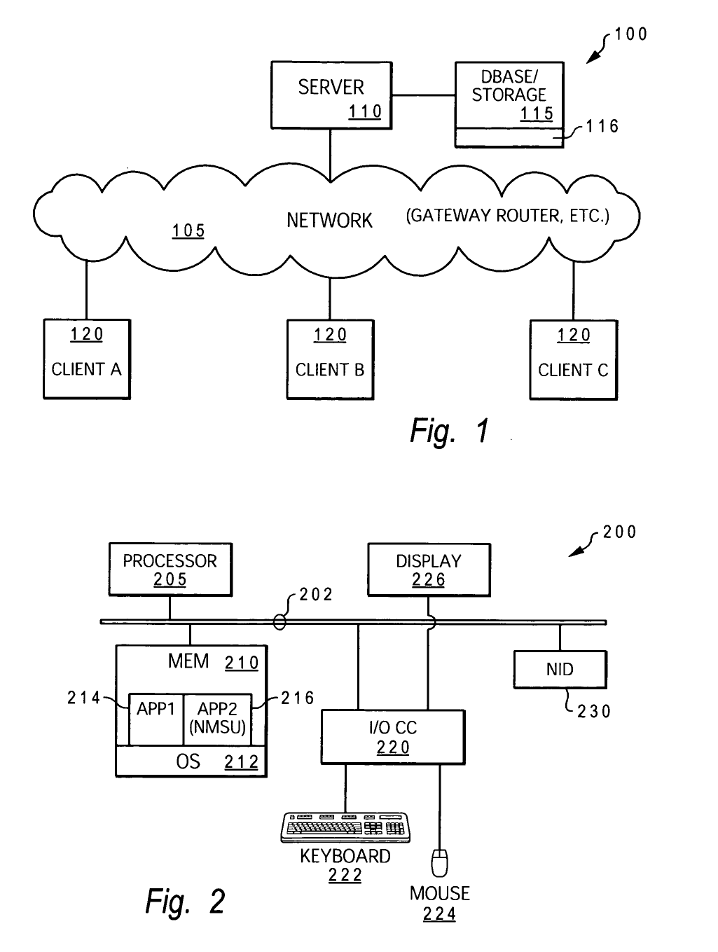

With reference now to the figures, FIG. 1 illustrates an exemplary network within which the network features of the invention may advantageously be practiced. Network 100 comprises a network backbone 105 to which is connected a plurality of client systems 120 labeled clients A, B and C in the illustrative embodiment. Also connected to network backbone 105 is network server 110, which hosts a storage device/database 115 in which is stored one or more electronic files 116 that may be accessed by users of client systems 120.

While network 100 is depicted as a simple set of connected blocks/devices, it should be understood that the network may be a complex network comprising many more devices and connection types. For example, network backbone 105 may include interconnected routers, gateways, and other devices interconnected via wired or wireless means. Likewise connections between clients 120 and server 110 may be via wired or wireless connection medium. Other variations/configurations of networks 100 that enable multiple users to access a single file on a networked-database are contemplated by the invention. Also, the network may be local area network (LAN) or wide area network (WAN).

FIG. 2 illustrates an exemplary data processing system (DPS) 200 that may be utilized as either one of client systems 120 or as network server 110. DPS 200 includes processor 205, memory 210 and input/output controller (I/OCC) 220, interconnected via system bus 202. Also coupled to system bus 202 is network interface device (NID) 230, which enables DPS 200 to connect to an external network, such as illustrated by FIG. 1.

I/OCC 220 operates to control the input devices, of which keyboard 222 and mouse 224 are illustrated. I/OCC 220 also controls various output devices, such as display 226. Access to the electronic file may be provided via a graphical interface on display 226, which also provides a user with a first message when the file is locked by another user and a second message when the file is subsequently released.

Memory 210 includes several software components that when executed on the processor 205 completes the basic operations of DPS 200 as well as the more specific processes of the invention. As illustrated, memory 210 includes operating system (OS) 212 and two applications, labeled Application1 214 and Application2 216. Depending on whether DPS 200 is being utilized as client system 120 or server 110, Application1 214 provides either client software or server software for completing respective network functions.

Application2 216 on client system 120 is a program application (e.g., word processing software or browser) that enables a user of client system 120 to query the server 110 for access to a specific file 116 stored on the network storage device 115 and open the file on the client system 120. On server 110, Application2 216 is NAMU and carries out the queuing and other functional features of the invention when multiple users request access to edit a single network file 116. For simplicity of description, the DPS 200 is assumed to be a network server and Application2 216 is referred to hereinafter as NAMU 216.

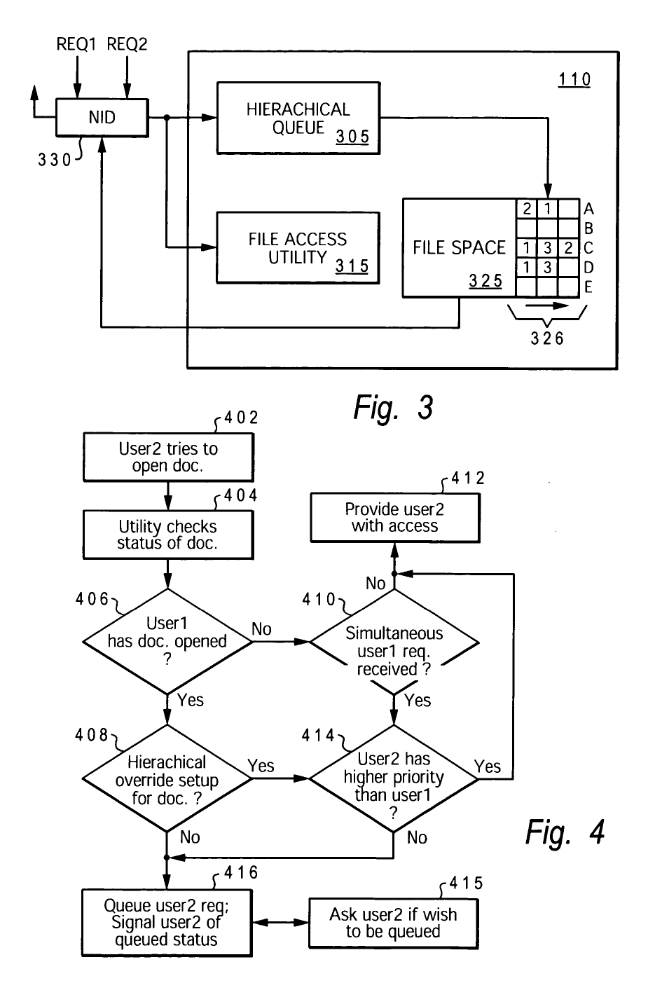

Turning now to FIG. 3, there is illustrated a block diagram representation of major components in a server that includes NAMU for handling multiple overlapping requests for access to edit a single network file. The server's NID 330 receives and evaluates incoming requests (e.g., Req1, Req2) for access to a single file. These requests are forwarded to an access-request queue 305 as well as to a file access utility 315 (i.e., the logic part of NAMU which controls the placement of requests within the access-request queue 305). The file access utility arranges the requests in an order based on pre-programmed criteria, some of which are described below. The order within the queue then determines the order by which access to the file within the file space 325 is granted for each received request for such access.

In one embodiment, each file is assigned a separate queue, while in another embodiment, a single queue is provided per database. This latter embodiment may be utilized for shared databases utilized for group projects, where a database-level priority is assigned to each group member and utilized when assigning files to access requests received. This also works within the embodiment in which each file is provided a separate “camping” block, as described below.

In the embodiment with camping blocks, when a request is received while the file is checked out to a previous user, the file is tagged with the ID of the client issuing the request. In this way, the user/client is made to “camp out” and wait for the file). This is illustrated in FIG. 3 as camping blocks 326, where A-E represents specific files and the number within the camping blocks appended to each one indicates which user(s) are next in line to be provided access to the file. Multiple users may camp on a file that is being used, and these users are arranged to receive sequential access to the file according to their location within the camping block. The order is indicated by directional arrow running from the leftmost block to the rightmost block.

The camping block allocates the file to the next user and may be utilized to trigger the automatic opening of the file on the client system of the next user. Thus, according to the illustrative embodiment, a separate queue and camping block are provided. However, in other implementations a single such facility may be utilized to complete both functions.

The queue is utilized to order the users according to some pre-established priority (or other) criteria. A basic implementation may provide a FIFO queue, where additional hierarchy and priority determinations are not required. In one implementation, higher priority may be provided to certain users or client systems on the network. Thus a network administrator or the client system associated with the network administrator may be given highest priority to access particular files on the network. Likewise, the original creator of a file (or manager of a project) may be given highest priority. When two users request access to a file that is locked by another user, regardless of the order in which the requests are received, the user with highest priority is placed first in the queue (or in the camping block) for access to the file when it is released. Thus a latter received request from a user with higher priority may be placed ahead of a previous request by another user that is currently in the queue.

Access by specific users to the file may be time-limited or subject to other pre-established limitations. In one implementation, for example, restricted times are defined during which only certain, pre-specified users may edit a file. For example, only users with management/administrative IDs may access a file within the 24 hours preceding a meeting or the due date for the file. Also, after regular work hours (e.g., 6:00 pm), only pre-approved personnel (e.g., administrative) may be allowed to access the database or specific file on the database.

When the second user has priority, one of several responses may be implemented by the NAMU. In a first implementation, if the second user has higher authority within the hierarchy, the second user may be inserted to the beginning of the queue, displacing the previously queued number one position to number two. In a second implementation, if the second user is the creator/owner of the file, the current user may be reclassified as a replication or save conflict version. As the file is opened for editing by the creator/owner, this version becomes the “official” version of the file. As an extension to the second implementation, a second user may only override the lock on the file and take over the file if such authority has been defined previously for that user. With this implementation, NAMU displays a dialog to the first user indicating the override is going to occur and the second user may be given the option to not override a previous user via a “confirm override” dialog box.

The above aspects of the invention are particularly applicable to group projects that involve various team members having different levels of priority. Using the ability to provide file-specific hierarchy for the access-request/hierarchical queue, the invention enables a project manager to be able to jump ahead of a user with lesser authority in a database. In a related implementation, during file creation, a user may specify the team members who will be accessing the file. The user may also associate priorities for each of the team members. In a structured environment, the priorities may be automatically generated using a default hierarchy specified by the database owner or using a project/department directory listing.

FIG. 4 illustrates the process by which the user is provided the option of camping on a file that is currently locked by another user. The process begins at block 402 at which a second user tries to open a file on his client system. The NAMU checks the status of the file at block 404 and at block 406 a determination is made whether a first user has the file opened. If a first user does not have the file open, a next determination is made at block 410 whether another request for the file was contemporaneously received (i.e., both requests are received at substantially the same time or the second request is received before the first request is given access to the file). If no other request was received, the NAMU provides the second user with access to the file as shown at block 412.

If, however, another contemporaneous request was received, a determination is made at block 414 whether the second user has higher priority than the other requesting user (e.g., user1). The second user is provided access as shown at block 412 when the second user's priority is higher than that of the other user.

Returning to decision block 406, when the file is in use by another user, a next determination is made at block 408 whether the specific file has hierarchical override feature established. If there is a hierarchical override feature for that file, then the determination at block 414 is made with a comparison of the second user against the user with previous access to the file. Notably, this process block enables a second user with higher priority to “boot” a lower priority user off a file. According to this implementation, certain safeguards are put in place to enable the first, lower priority user to save his/her edits to the file and be alerted of the need to release the file for use by the second, higher authority user. The specific release protocol for this implementation may range from an automatic/instantaneous boot (or save then boot) to a “camp until release”, whereby the second user is made to wait until the first user completes his editing of the file and closes the file.

When there is no override set and/or the second user does not have higher priority than the other user, the access request of the second user is queued by the NAMU and the second user is provided a message indicating the queued status, as shown at block 416. This message may include an indication of where in the queue the second user is relative to the other user-requests, and, if each user access is time-limited, the estimated time before the second user will be provided access to the file. In one embodiment, the second user is provided the option of being placed in queue as shown at block 415. Accordingly, a dialog box is provided offering the second user with the option to get in queue to edit the record/file. If the user selects that option, the NAMU appends the user ID to the access-request queue. Once placed in the queue, the queued user is given an indication of how deep he is within the queue, in one embodiment.

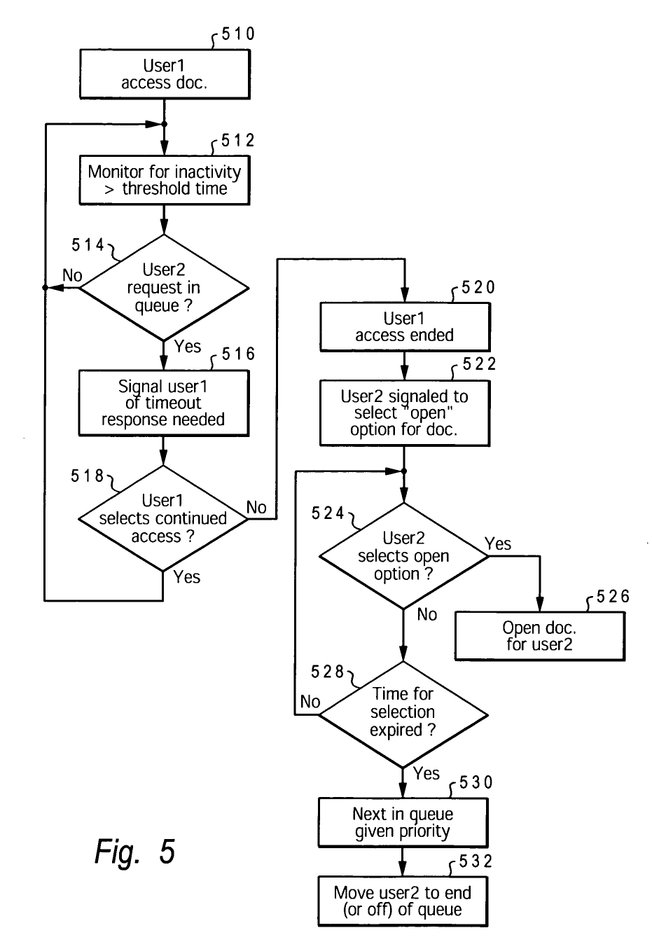

In another embodiment, the time in queue is limited and a time-out mechanism is provided to prevent false “in-use” conditions (i.e., a file appears to be in use by user who has forgotten to release the file). As mentioned above, each user may also be is limited to a threshold amount of time after the user is provided access. FIG. 5 provides a flow chart of the processing involved with managing access times according to one embodiment. The process begins at block 510 when the first user (user1) accesses the file. Following, at block 512, the NAMU monitors the user's access for a period of inactivity that is greater than some pre-established time. A determination is made at block 514 whether there are other users queued to access the file. If there are no other users requesting access to the file, NAMU allows the first user to maintain its access indefinitely.

Also, a preset period of inactivity with the file while there are other users camped on the file triggers generation of a message to the user. Also, in another embodiment, whenever there are other users camped on the file, the previous user is given a pre-set amount of time to complete his access to the parent document. The first user is sent a timeout signal as shown at block 516. This signal may be communicated to the user via a pop up/dialog box. A determination is made at block 518 whether the user requests continued access to the file. If the time-out is not automatic, the first user is allowed to continue his/her access until a next timeout period expires.

When the user does not respond to this prompt from the NAMU to indicate a desire to continue accessing/editing the file, then the user's access is timed out, as provided at block 520. The user may respond by selecting a “still in use” option or releasing the file. According to one embodiment, with the later option, the user may release the parent copy of the file but retain a child copy for non-editing purposes. When the user is timed-out, a message of the time-out is sent to the user, and the user is moved to end of queue. The following users within the queue are moved up one spot, and, in one implementation, an email, popup dialog, or instant message may be sent to queued users indicating the new position within the queue. Contemporaneously, the next user in queue is sent a message that he/she may access the file, as shown at block 522.

The specific type of message/alert to the second user may differ based on user-preference or implementation. For example, in alternate embodiments, an instant message or an e-mail is sent to the queued second user, who then has to access the database and open the file. NAMU verifies that the access to the file is by the correct user by checking the user ID or client system ID, etc.

In the illustrative embodiment, NAMU generates a popup dialog to the second user that the file can now be edited. In one version of this implementation, the second user may then click “OK” to check out the file. A determination is made at block 524 whether the second user has selected the option to edit the file. If the second user selects that option, the file is opened for editing by the second user, as provided in block 526. Assuming no immediate selection is recorded for the second user, a next determination is made at block 528 whether the time for making the selection has expired. This check is necessary because the second user may have requested to be placed in queue several users ago (potentially several hours prior) and may no longer be waiting to edit the document. If the time for the selection has expired, the next user in the queue is given the priority to access the file as stated at block 530, and the second user is move to the end of queue, as indicated at block 532.

As a final matter, it is important that while an illustrative embodiment of the present invention has been, and will continue to be, described in the context of a fully functional computer system, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a network environment with a storage facility with user-accessible files, a method comprising:
granting a first user access to a file stored on said storage facility;
receiving a request from a second user for access to the file while the file is being accessed by the first user;
queuing said second user to be given a next access to the file when the access by the first user is terminated;
automatically signaling said second user when said access by the first user has terminated, wherein said second user is alerted when said file is available for access by said second user and said second user's access is provided ahead of a subsequent request for access by another user while said access by said first user is ongoing.

2. The method of claim 1, further comprising:
parsing the request for one of a user identifier (ID) or client system ID;
placing said user ID or client system ID in a queue; and
sequentially assigning access to said file to the user ID or client system ID at the head of the queue.

3. The method of claim 1, further comprising:
tagging said file at said storage facility with the identifier (ID) of at least said second user when access to said file belongs to said first user; and
assigning a next access to a first of the at least said second user whose ID is tagged to said file.

4. The method of claim 2, further comprising:
allocating said second user to a location within the queue based on a pre-assigned priority of users with access to said file, wherein the second user is placed ahead of a third user when the second user has higher priority, regardless of when the queued request for the second user was received relative to the queued request from the third user.

5. The method of claim 4, wherein said priority is a time-based priority, wherein said method includes:
barring the second user from accessing the file during a pre-specified time during which a the third user is allowed access; and
providing access to the second user outside of the pre-specified time when the file is available for access and said second user is at the head of the queue.

6. The method of claim 1, further comprising:
establishing a pre-determined amount of time for each user to access the file; and
when the pre-determined amount of time expires for the first user and at least one other user is presently in queue for the access, terminating the access of the first user and providing said access to the second user.

7. The method of claim 6, further comprising:
signaling said first user of the end of the pre-determined amount of time;
saving the file on the storage facility; and
closing the file from access by the first user.

8. The method of claim 7, wherein said closing includes:
prompting the user to select whether to retain a copy of the file; and
providing the user with a child copy of the file, while the file is assigned to the second user.

9. The method of claim 6, wherein said providing step is completed utilizing one of a plurality of user-access processes from among:
transmitting a dialog box prompting said second user to select to open the file at the user's client system;
automatically activating an application on a client system of the second user to open up the file; and
providing a visual/audible signal recognizable b the second user as an indication that said file is available for access at the storage facility.

10. The method of claim 9, wherein said transmitting and providing steps includes a time-out feature wherein access to the file by the second user is required before expiration of a preset time, and failure of said second user to access said file within the preset time causes said second user to forfeit the access permission and be placed at the end of the queue, whereby another queued request by a third user is provided said access.

11. A computer program product comprising:
a computer readable medium; and
program instructions on said medium that when executed completes the following:
enabling storage of a file at a storage facility of a network that is accessible to multiple users;
granting a first user access to a file stored on said storage facility;
receiving a request from a second user for access to the file while the file is being accessed by the first user;
queuing said second user to be given a next access to the file when the access by the first user is terminated;
automatically signaling said second user when said access by the first user has terminated, wherein said second user is alerted when said file is available for access by said second user and said second user's access is provided ahead of a subsequent request for access by another user while said access by said first user is ongoing.

12. The computer program product of claim 11, further comprising program instructions for:
parsing the request for one of a user identifier (ID) or client system ID;
placing said user ID or client system ID in a queue; and
sequentially assigning access to said file to the user ID or client system ID at the head of the queue.

13. The computer program product of claim 1, further comprising program instructions for:
tagging said file at said storage facility with the identifier (ID) of at least said second user when access to said file belongs to said first user; and
assigning a next access to a first of the at least said second user whose ID is tagged to said file.

14. The computer program product of claim 12, further comprising program instructions for:
allocating said second user to a location within the queue based on a pre-assigned priority of users with access to said file, wherein the second user is placed ahead of a third user when the second user has higher priority, regardless of when the queued request for the second user was received relative to the queued request from the third user; and
when said priority is a time-based priority:
barring the second user from accessing the file during a pre-specified time during which a the third user is allowed access; and
providing access to the second user outside of the pre-specified time when the file is available for access and said second user is at the head of the queue.

15. The computer program product of claim 11, further comprising program instructions for:
establishing a pre-determined amount of time for each user to access the file; and
when the pre-determined amount of time expires for the first user and at least one other user is presently in queue for the access:
signaling said first user of the end of the pre-determined amount of time;
saving the file on the storage facility;
closing the file from access by the first user; and
providing said access to the second user, wherein said providing step is completed utilizing one of a plurality of user-access processes from among:
transmitting a dialog box prompting said second user to select to open the file at the user's client system;
automatically activating an application on a client system of the second user to open up the file; and
providing a visual/audible signal recognizable b the second user as an indication that said file is available for access at the storage facility.

16. The computer program product of claim 15, wherein said program instructions for closing the file includes instructions for:
prompting the user to select whether to retain a copy of the file; and
providing the user with a child copy of the file, while the file is assigned to the second user.

17. The computer program product of claim 15, wherein said program instructions for transmitting and providing includes a time-out feature wherein access to the file by the second user is required before expiration of a preset time, and failure of said second user to access said file within the preset time causes said second user to forfeit the access permission and be placed at the end of the queue, whereby another queued request by a third user is provided said access.

18. A network comprising:
a network management server;
a storage facility with at least one file that is accessible by multiple users via the network management server;
a plurality of client systems coupled to the network backbone and utilized by respective ones of said multiple users to access said file; and
a network-database access management utility (NAMU) that completes the following:
enabling storage of a file at a storage facility of a network that is accessible to multiple users;
granting a first user access to a file stored on said storage facility;
receiving a request from a second user for access to the file while the file is being accessed by the first user;
queuing said second user to be given a next access to the file when the access by the first user is terminated;
automatically signaling said second user when said access by the first user has terminated, wherein said second user is alerted when said file is available for access by said second user and said second user's access is provided ahead of a subsequent request for access by another user while said access by said first user is ongoing.

19. The network of claim 18, wherein said NAMU further comprises program logic for:
parsing the request for one of a user identifier (ID) or client system ID;
placing said user ID or client system ID in a queue; and
sequentially assigning access to said file to the user ID or client system ID at the head of the queue
tagging said file at said storage facility with the ID of at least said second user when access to said file belongs to said first user; and
assigning a next access to a first of the at least said second user whose ID is tagged to said file.

20. The network of claim 19, said NAMU comprising program logic for:
allocating said second user to a location within the queue based on a pre-assigned priority of users with access to said file, wherein the second user is placed ahead of a third user when the second user has higher priority, regardless of when the queued request for the second user was received relative to the queued request from the third user; and
when said priority is a time-based priority:
barring the second user from accessing the file during a pre-specified time during which a the third user is allowed access; and
providing access to the second user outside of the pre-specified time when the file is available for access and said second user is at the head of the queue.

21. The network of claim 18, said NAMU further comprising program logic for:
establishing a pre-determined amount of time for each user to access the file; and
when the pre-determined amount of time expires for the first user and at least one other user is presently in queue for the access:
signaling said first user of the end of the pre-determined amount of time;
saving the file on the storage facility;
closing the file from access by the first user; and
providing said access to the second user, wherein said providing step is completed utilizing one of a plurality of user-access processes from among:
transmitting a dialog box prompting said second user to select to open the file at the user's client system;
automatically activating an application on a client system of the second user to open up the file; and
providing a visual/audible signal recognizable b the second user as an indication that said file is available for access at the storage facility; and
wherein said program logic for transmitting and providing includes a time-out feature wherein access to the file by the second user is required before expiration of a preset time, and failure of said second user to access said file within the preset time causes said second user to forfeit the access permission and be placed at the end of the queue, whereby another queued request by a third user is provided said access.

22. The network of claim 21, wherein said program logic for closing the file includes logic for:
prompting the user to select whether to retain a copy of the file; and
providing the user with a child copy of the file, while the file is assigned to the second user.
